(19) United States
(12) Patent Application Publication
(10) Pub. No.: US 2014/0074413 A1
(43) Pub. Date: Mar. 13, 2014

(54) DETECTION OF GENERATOR STATOR INTER-CIRCUIT FAULTS

(71) Applicants: Shantanu Som, Dubai (AE); Zeeky Ashiono Bukhala, Clifton Park, NY (US)

(72) Inventors: Shantanu Som, Dubai (AE); Zeeky Ashiono Bukhala, Clifton Park, NY (US)

(73) Assignee: GENERAL ELECTRIC COMPANY, Schenectady, NY (US)

(21) Appl. No.: 13/613,721

(22) Filed: Sep. 13, 2012

(51) Int. Cl. G06F 19/00

(52) U.S. Cl. 702/58

(57) ABSTRACT

Aspects of the invention provide a system and method for detecting inter-circuit faults within a generator stator. In one embodiment, a computer system includes: a sampler for sampling phase voltages and phase currents of a generator stator; a plurality of pre-defined blocks for enabling, based on the sampled phase voltages and currents, an inter-circuit fault detection scheme; a level detection block for determining, in response to the enabled inter-circuit fault detection scheme, a plurality of differences between the sampled phase voltages; and a comparison logic device for comparing, in response to the enabled inter-circuit fault detection scheme, each of the differences of the sampled phase voltages and determining, based on the differences, an inter-circuit fault within at least one phase of the generator stator. The system may also include a negative sequence voltage block for detection of inter-circuit fault within a generator stator.

### BACKGROUND OF THE INVENTION

The subject matter disclosed herein relates generally to a multi-circuit generator stator and, more particularly, to a system for detecting generator stator inter-circuit faults.

Present day competitive market space for higher frame generators has challenged original equipment manufacturers to develop generators with increasing power density. This is achieved by providing generators with improved cooling methods and also introducing parallel circuits in each phase. In order to ensure reliable operation and enhanced availability of these units, manufacturers are obliged per applicable international codes and standards to provide protection systems in place that will ensure isolation of the unit in case of an internal fault.

For example, current protection systems provide stator ground fault protection through 100% stator ground fault detection (64TN), 3^{rd} harmonic stator ground fault detection (27TN), neutral over-voltage detection (59N), and auxiliary over-voltage detection (59X).

### BRIEF DESCRIPTION OF THE INVENTION

Aspects of the invention provide a system and method for detecting inter-circuit faults within a generator stator. In one embodiment, a computer system includes: a sampler for sampling phase voltages and phase currents of a generator; a plurality of pre-defined blocks for enabling, based on the sampled phase voltages and currents, an inter-circuit fault detection scheme; a level detection block for determining, in response to the enabled inter-circuit fault detection scheme, a plurality of differences between the sampled phase voltages; and a comparison logic device for comparing, in response to the enabled inter-circuit fault detection scheme, each of the differences of the sampled phase voltages and determining, based on the differences, an inter-circuit fault within at least one phase of the generator stator. The system may also include a negative sequence voltage block for detection of generator phase voltage unbalance.

A first aspect of the disclosure provides a computer system, comprising: a sampler for sampling phase voltages and phase currents of a generator stator; a plurality of pre-defined blocks for enabling, based on the sampled phase voltages and currents, an inter-circuit fault detection scheme; a level detection block for determining, in response to the enabled inter-circuit fault detection scheme, a plurality of differences between the sampled phase voltages; and a comparison logic device for comparing, in response to the enabled inter-circuit fault detection scheme, each of the differences of the sampled phase voltages and determining, based on the differences, an inter-circuit fault within at least one phase of the generator stator.

A second aspect provides a computer program comprising program code embodied in at least one computer-readable medium, which when executed, enables a computer system to implement a method of detecting inter-circuit faults within a generator stator, the method comprising: sampling phase voltages of the generator stator; sampling phase currents of the generator stator; enabling, based on the sampled phase voltages and currents, an inter-circuit fault detection scheme; determining, in response to the enabling, a plurality of differences between the sampled phase voltages; and comparing, in response to the enabling, each of the differences of the sampled phase voltages and determining, based on the differences, an inter-circuit fault within at least one phase of the generator stator.

A third aspect provides a computer-implemented method for detecting inter-circuit faults within a generator stator, the method comprising: sampling phase voltages of the generator stator; sampling phase currents of the generator stator; enabling, based on the sampled phase voltages and phase currents, an inter-circuit fault detection scheme; determining, in response to the enabling, a plurality of differences between the sampled phase voltages; and comparing, in response to the enabling, each of the differences of the sampled phase voltages and determining, based on the differences, an inter-circuit fault within at least one phase of the generator stator.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a circuit diagram of the phases of the windings for a multi-circuit generator stator according to an embodiment of the invention.

FIG. 2 shows an illustrative environment for detecting inter-circuit faults in a generator stator according to an embodiment of the invention.

FIG. 3 shows a schematic block diagram of a system for detecting inter-circuit faults in a generator stator according to embodiments of the invention.

FIG. 4 shows a flow diagram of a method for detecting inter-circuit faults in a generator stator according to embodiments of the invention.

FIG. 5 shows a flow diagram of a method for detecting inter-circuit faults in a generator stator according to embodiments of the invention.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As mentioned above, the subject matter disclosed herein relates generally to a multi-circuit generator stator and, more particularly, to a system for detecting generator stator inter-circuit faults.

Present day competitive market space for higher frame generators has challenged original equipment manufacturers to develop generators with higher power density. This is achieved by providing generators with improved cooling methods and also introducing parallel circuits in each phase. In order to ensure reliable operation and enhanced availability of these units, manufacturers are obliged to provide protection systems in place per international standards and grid codes that will ensure isolation of the unit in case of an internal fault.

For example, current protection systems provide stator ground fault protection through 100% stator ground fault detection (64TN), 3rd harmonic stator ground fault detection (27TN), neutral over-voltage detection (59N), and auxiliary over-voltage detection (59X). However, none of the current protection systems provide capability of detecting an inter-circuit fault in a multi-circuit generator stator.

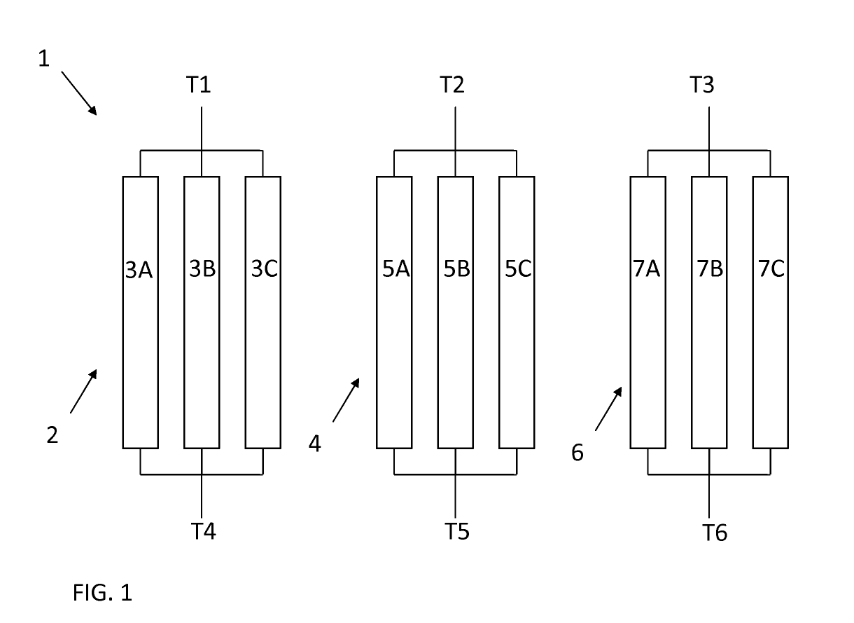

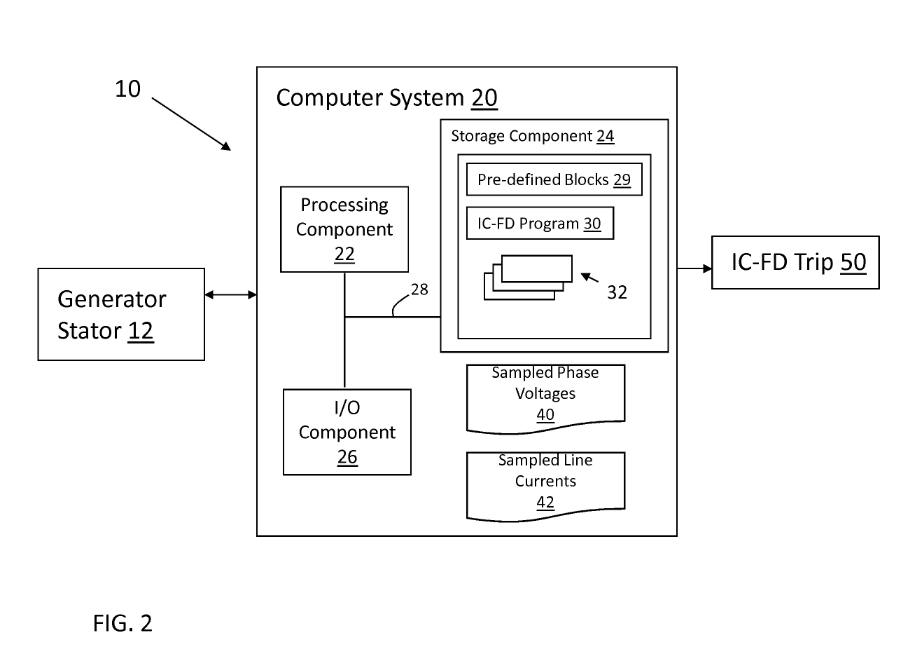

Turning now to FIG. 1, a circuit diagram of the phases 2, 4, 6 of the winding 1 for a generator stator 12 (FIG. 2) according to embodiments of the invention is shown. As shown, leads T1 and T4 form the first phase 2, leads T2 and T5 form the second phase 4, and leads T3 and T6 form the third phase 6. Between each pair of leads for each phase is a plurality of circuits. An inter-circuit fault is a fault that occurs between the circuits of a phase. For example, between leads T3 and T6 for the third phase are circuits 7A, 7B, and 7C, and an inter-circuit fault would be a fault that occurs between circuits 7A and 7B. Alternatively, an inter-circuit fault could occur between circuits 7B and 7C, or between circuits 7A and 7C. Inter-circuit faults of these types, undetected and/or not isolated, can cause catastrophic damage to generator stators.

Aspects of the invention provide a system and method for detecting inter-circuit faults within a generator stator. In one embodiment, a computer system includes: a sampler for sampling phase voltages and phase currents of a generator; a plurality of pre-defined blocks for enabling, based on the sampled phase voltages and currents, an inter-circuit fault detection scheme; a level detection block for determining, in response to the enabled inter-circuit fault detection scheme, a plurality of differences between the sampled phase voltages; and a comparison logic device for comparing, in response to the enabled inter-circuit fault detection scheme, each of the differences of the sampled phase voltages and determining, based on the differences, an inter-circuit fault within at least one phase of the generator stator. The system may also include a negative sequence voltage block for detection of phase voltage unbalance within a generator stator. The technical effect of such a system is the ability to detect inter-circuit faults within a generator stator. The inter-circuit fault detection scheme provided by this disclosure may be implemented in existing and any future generator protection relays.

Turning now to FIG. 2, shows an illustrative environment 10 for detecting inter-circuit faults on a generator stator 12 according to embodiments of the invention. To this extent, environment 10 includes a computer system 20 that can perform a process described herein in order to detect inter-circuit faults within a generator stator 12. In particular, computer system 20 is shown including an inter-circuit fault detection (IC-FD) program 30, which makes computer system 20 operable to detect inter-circuit faults within a generator stator 12 by performing a process described herein. Further shown in computer system 20 are pre-defined blocks 29, which, as will be described later herein, enable IC-FD program 30.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as pre-defined blocks 29 and/or IC-FD program 30, which are at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more I/O devices, which enables user to interact with computer system 20 and/or one or more communications devices to enable a system user to communicate with computer system 20 using any type of communications link. Further, pre-defined blocks 29 and/or IC-FD program 30 can manage (e.g., store, retrieve, create, manipulate, organize, present, etc.) the data, such as sampled phase voltages 40 and/or sampled line currents 42, using any solution.

In any event, computer system 20 can comprise one or more general purpose computing articles of manufacture (e.g., computing devices) capable of executing program code, such as pre-defined blocks 29 and/or IC-FD program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, pre-defined blocks 29 and/or IC-FD program 30 can be embodied as any combination of system software and/or application software and/or firmware application codes.

Further, pre-defined blocks 29 and/or IC-FD program 30 can be implemented using a set of modules 32. In this case, a module 32 can enable computer system 20 to perform a set of tasks used by pre-defined blocks 29 and/or IC-FD program 30, and can be separately developed and/or implemented apart from other portions of pre-defined blocks 29 and/or IC-FD program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software and/or firmware. Further, it is understood that some of the functionality discussed herein may not be implemented or additional functionality may be included as part of the computer system 20.

When computer system 20 comprises multiple computing devices, each computing device can have only a portion of pre-defined blocks 29 and/or IC-FD program 30 fixed thereon (e.g., one or more modules 32). However, it is understood that computer system 20, pre-defined blocks 29, and/or IC-FD program 30 are only representative of various possible equivalent computer systems that may perform a process described herein. To this extent, in other embodiments, the functionality provided by computer system 20, pre-defined blocks 29 and/or IC-FD program 30 can be at least partially implemented by one or more computing devices that include any combination of general and/or specific purpose hardware with or without program code. In each embodiment, the hardware, firmware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, pre-defined blocks 29 and IC-FD program 30 enables computer system 20 to detect inter-circuit faults in a generator stator 12. As shown in FIG. 2, if an inter-circuit fault is detected, computer system 20 will generate an IC-FD Trip signal 50. Such trip signal can be utilized to isolate and de-energize the generator stator 12.

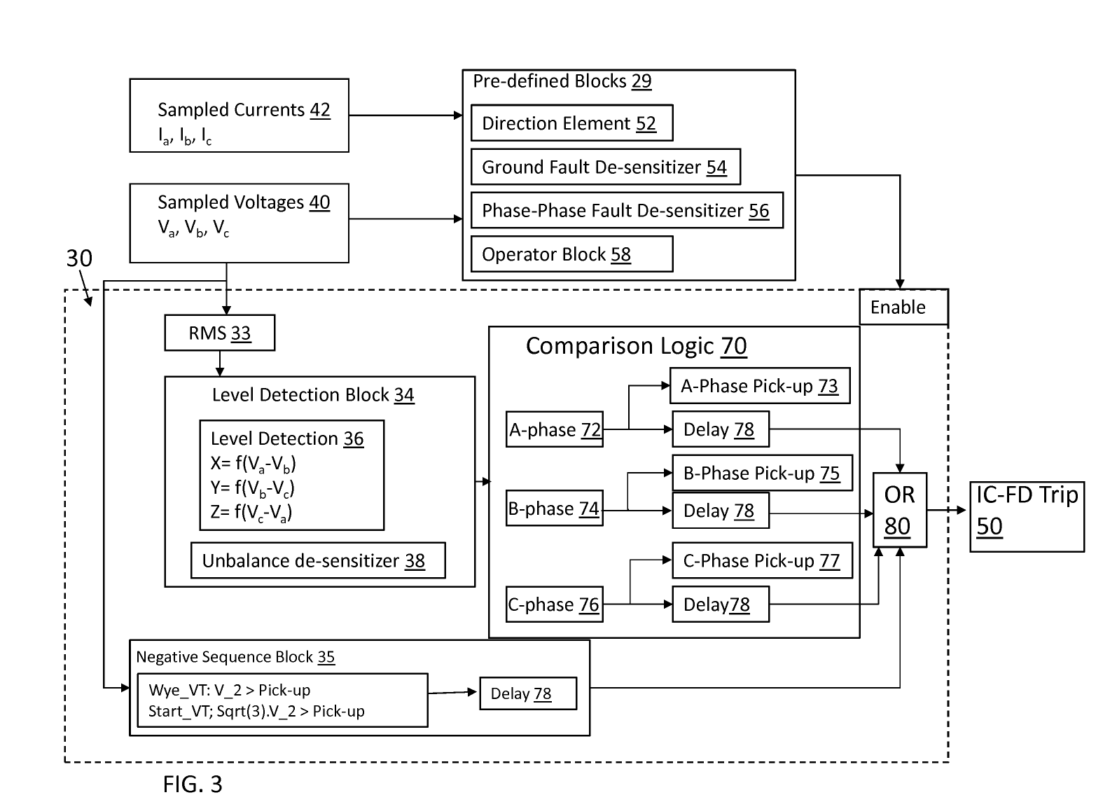

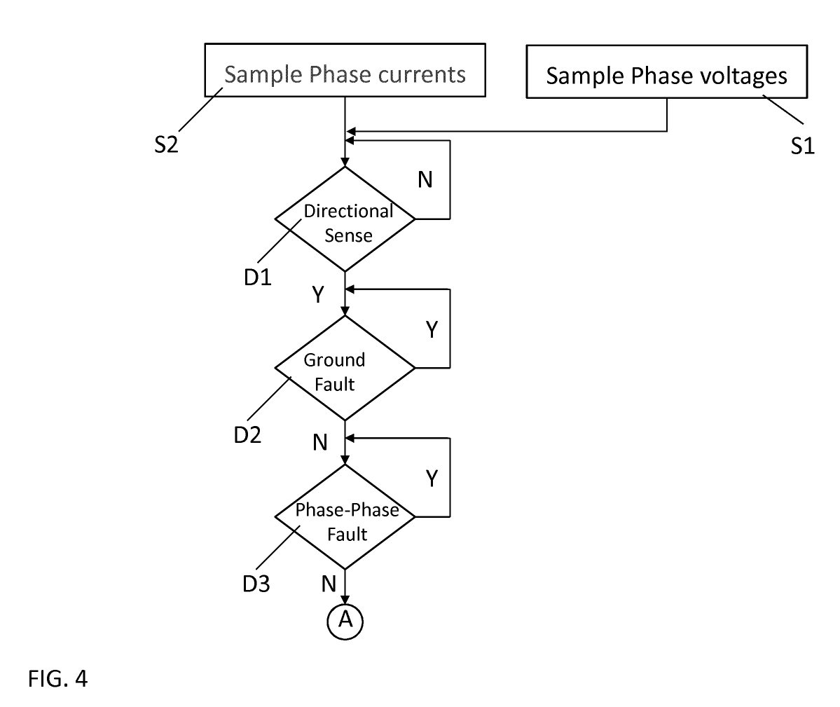

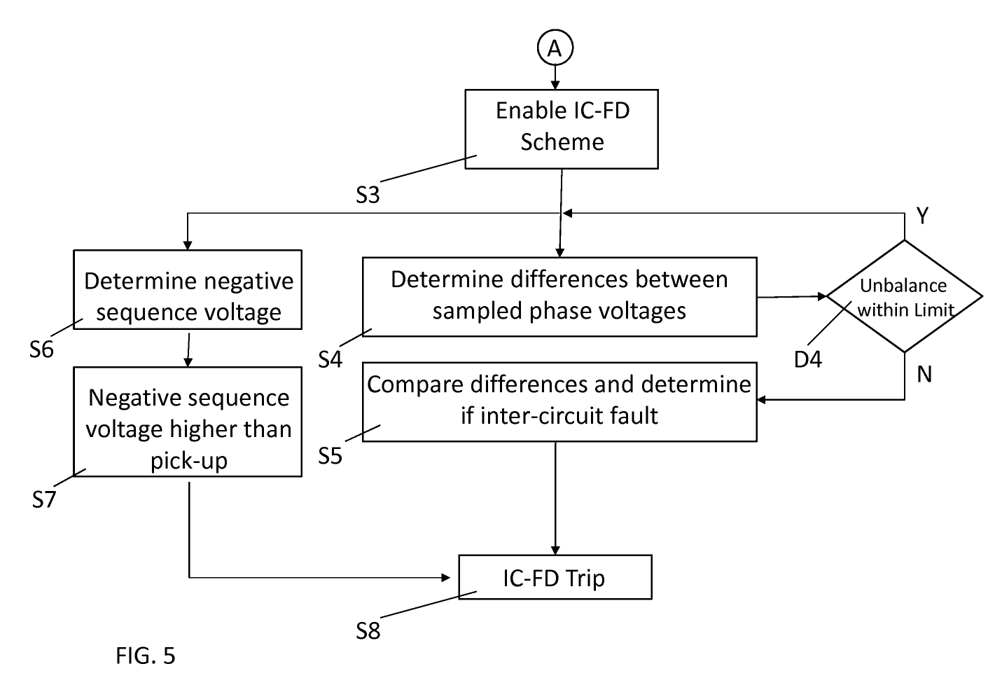

Turning now to FIG. 3, a schematic block diagram of a system for detecting inter-circuit faults in a generator stator 12 (FIG. 2) according to embodiments of the invention is shown. FIGS. 4 and 5 show a flow diagram of a method for detecting inter-circuit faults using this system shown in FIG. 3.

At S1, a sampler samples phase voltages 40 (Vₐ, V_{b}, V_{c}) for each phase of the generator stator 12 (FIG. 2). At S2, the sampler samples phase currents 42 (Iₐ, I_{b}, I_{c}) for each phase of the generator stator 12 (FIG. 2). Further, it is understood that phase voltages 40 and phase currents 42 of generator stator 12 may be sampled using any now known or later developed sampling technique.

A plurality of pre-defined blocks 29 are provided for enabling, based on these sampled phase voltages 40 and phase currents 42, an inter-circuit fault detection (IC-FD) program 30 (i.e., scheme). As shown in FIG. 3, IC-FD program 30 includes a level detection block 34, a comparison logic 70, and a negative sequence block 35. Also, IC-FD program 30 includes an “OR” gate 80. The features of IC-FD program 30 will be discussed later herein.

The plurality of pre-defined blocks 29 enable the IC-FD program 30 only in particular situations, based on the sampled phase voltages 40 and phase currents 42. For example, at D1, the direction of the fault is sensed using directional element 52. That is, directional element 52 determines whether the fault is inside or outside of the generator. If the fault is not within the generator (“N”), then the directional element 52 continues to determine, at D1, whether there is a fault inside the generator. Once the directional element 52 determines that a fault is within the generator (“Y”), at D2, a ground fault de-sensitizer 54 determines, based on the sampled phase voltages 40, whether the fault is a ground fault. The parameter threshold to determine whether a fault is a ground fault may be set by a user. For example, if a sampled phase voltage 40 is less than or equal to approximately twenty percent (20%) rated, then the fault may be considered by the pre-defined blocks 29 as a ground fault (“Y”). In this case, the ground fault de-sensitizer 54, at D2, will continue to determine if a ground fault exists.

Once ground fault de-sensitizer 54 determines that a ground fault does not exist (“N”), a phase-phase fault de-sensitizer 56 determines, at D3, based on the sampled phase voltages 40, whether the fault is a phase-phase fault. The parameter threshold for determining whether a fault is a phase-phase fault may be set by a user. For example, if any two of the sampled phase voltages 40 is less than approximately sixty percent (60%) rated, then the fault may be considered a phase-phase fault. It is only if the fault is not a phase-phase fault (“N”), that the IC-FD program 30 is enabled (S3). In this way, the pre-defined blocks (directional element 52, ground fault de-sensitizer 54, and phase-phase fault de-sensitizer 56) prevent IC-FD program 30 from being enabled unless the fault is within the generator stator 12 (FIG. 2), the fault is not a ground fault, and the fault is not a phase-phase fault. Pre-defined block 29 can also be provided with an operator block 58, to prevent IC-FD program 30, from being enabled. Operator block 58, is a user configurable block that, when selected, will prevent IC-FD program 30 from being enabled. The operator block 58, along with pre-defined blocks, directional element 52, ground fault de-sensitizer 54, and phase-phase fault de-sensitizer 56, collectively prevent IC-FD program 30 from being enabled.

Once the IC-FD program 30 is enabled, the level detection 36 of the level detection block 34, determines, at S4, the differences between each of the sampled phase root mean square (RMS) voltages 40. As seen in FIG. 3, the sampled voltages 40 go through the RMS block 33 prior to the level detection block 34. With regard to the level detection 36, for example, X is the difference between sampled phase RMS voltage Vₐ and sampled phase RMS voltage V_{b}. Y is the difference between sampled phase RMS voltage V_{b} and sampled phase RMS voltage V_{c}. Z is the difference between sampled phase RMS voltage V_{c} and sampled phase RMS voltage Vₐ. Level detection block 34 also includes an unbalance de-sensitizer 38 that does not allow the comparison logic 70, to run when the unbalance in sampled phase voltages Vₐ, V_{b}, V_{c} are within user settable limits. For example, at D4, only if the unbalance is not within a pre-defined, user set, limit (“N”), that the comparison logic 70 (S5) is run. Typically, a ±10% unbalance limit can be set to allow phase loading unbalance. Unbalance de-sensitizer 38 may include a plurality of relays.

At S5, these differences (X, Y, Z) of the sampled phase RMS voltages 40 are compared by comparison logic 70. Based on the differences (X, Y, Z), comparison logic 70, using OR gate 80, determines whether an inter-circuit fault is within at least one phase of the generator stator 12 (FIG. 2). That is, A-phase 72 would be logic high “1” if an inter-circuit fault is within the T1-T4 phase 2 (sampled phase RMS voltage Vₐ). When A-Phase 72 logic high is reached, an A-phase pick-up 73 (i.e., a memory flag to register an A-phase inter-circuit fault event), is set high. A-phase pick-up 73 logic can be programed as a trending parameter that could be reviewed for pick-up during diagnosis of an inter-circuit fault event. B-phase 74 would be logic high “1” if an inter-circuit fault is within the T2-T5 phase 4 (sampled phase RMS voltage V_{b}). When B-Phase 74 logic high is reached, a B-phase pick-up 75 (i.e., a memory flag to register a B-phase inter-circuit fault event) is set high. B-phase pick-up 75 logic can be programed as a trending parameter that could be reviewed for pick-up during diagnosis of an inter-circuit fault event. C-phase 76 would be logic high “1” if an inter-circuit fault is within the T3-T6 phase 6 (sampled phase RMS voltage V_{c}). When C-Phase 76, logic high is reached, a C-phase pick-up 77 (i.e., a memory flag to register a C-phase inter-circuit fault event) is set high. C-phase pick-up 77 logic can be programed as a trending parameter that could be reviewed for pick-up during diagnosis of an inter-circuit fault event. Comparison logic 70 may also include delay 78 (i.e., timer blocks) for each phase 72, 74, 76 to ensure isolation of the generator under a sustained inter-circuit fault.

Along with the level detection block 34 and comparison logic 70, a parallel negative sequence over-voltage (5_92) block 35 is provided. The negative sequence block 35 receives the sampled voltages 40. Negative sequence block 35 accepts sampled phase voltages 40 through star or delta voltage transformer connections. Sampled phase voltages 40 are processed in negative sequence block 35 in order to obtain a negative sequence voltage (V_2). Negative sequence voltage (V_2) is compared with a user settable threshold to detect over voltage condition (59_2). Negative sequence over-voltage detection through negative sequence block 35 is used to detect loss of one or two phases, or a non-symmetrical voltage condition, that corresponds to an inter-circuit fault condition. At S6, the negative sequence voltages are determined. At S7, if the negative sequence voltage are greater than a threshold settable by user (i.e., a pick-up), for a preset delay 78, an IC-FD signal is generated. If an inter-circuit fault is detected in any of the phases through a combination of level detection 34 and comparison logic 70, or negative sequence block 35, at S8 an IC-FD trip 50 is generated, which could be used for isolating and de-energizing the generating unit.

While shown and described herein as a method and system for detecting inter-circuit faults in a generator stator 12 (FIG. 2), it is understood that aspects of the invention further provide various alternative embodiments. For example, in one embodiment, the invention provides a computer program fixed in at least one computer-readable medium, which when executed, enables a computer system to detect inter-circuit faults in a generator stator 12 (FIG. 2). To this extent, the computer-readable medium includes program code, such as pre-defined blocks 29 and/or IC-FD program 30 (FIG. 2), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer system, comprising:
a sampler for sampling phase voltages and phase currents of a generator stator;
a plurality of pre-defined blocks for enabling, based on the sampled phase voltages and currents, an inter-circuit fault detection scheme;
a level detection block for determining, in response to the enabled inter-circuit fault detection scheme, a plurality of differences between the sampled phase voltages; and
a comparison logic device for comparing, in response to the enabled inter-circuit fault detection scheme, each of the differences of the sampled phase voltages and determining, based on the differences, an inter-circuit fault within at least one phase of the generator stator.

2. The system of claim 1, further comprising a negative sequence over-voltage block for determining, based on the sampled phase voltages, a negative sequence voltage and determining if the negative sequence voltage is greater than a threshold.

3. The system of claim 1, wherein the level detection block further includes: comparing the sampled phase voltages, and determining if an unbalance between the sampled phase voltages is within a pre-defined limit.

4. The system of claim 1, wherein the plurality of pre-defined blocks includes a directional element for determining, based on the sampled phase voltages and currents, if a fault is within the generator stator.

5. The system of claim 1, wherein the plurality of pre-defined blocks includes a ground fault de-sensitizer for determining, based on the sampled phase voltages, if a fault is a ground fault.

6. The system of claim 1, wherein the plurality of pre-defined blocks includes a phase-to-phase fault de-sensitizer for determining, based on the sampled phase voltages, if a fault is a phase-phase fault.

7. A computer program comprising program code embodied in at least one computer-readable medium, which when executed, enables a computer system to implement a method of detecting inter-circuit faults within a generator stator, the method comprising:
sampling phase voltages of the generator stator;
sampling phase currents of the generator stator;
enabling, based on the sampled phase voltages and currents, an inter-circuit fault detection scheme;
determining, in response to the enabling, a plurality of differences between the sampled phase voltages; and
comparing, in response to the enabling, each of the differences of the sampled phase voltages and determining, based on the differences, an inter-circuit fault within at least one phase of the generator stator.

8. The computer program of claim 7, further comprising determining a negative sequence voltage, based on the sampled phase voltages, and determining if the negative sequence voltage is higher than a threshold.

9. The computer program of claim 7, further comprising comparing the sampled phase voltages, and determining if an unbalance between the sampled phase voltages is within a pre-defined limit.

10. The computer program of claim 9, wherein comparing each of the differences of the sampled phase voltages is further in response to determining that the balance between the sampled phase voltages is within the pre-defined limit.

11. The computer program of claim 7, further comprising filtering, using a timer block, to ensure isolation of a generator under a sustained inter-circuit fault.

12. The computer program of claim 7, wherein enabling the inter-circuit fault detection scheme further comprises: determining, based on the sampled phase voltages and current, if a fault is within the generator stator.

13. The computer program of claim 7, wherein enabling the inter-circuit fault detection scheme further comprises: determining, based on the sampled phase voltages, if a fault is a ground fault.

14. The computer program of claim 7, wherein enabling the inter-circuit fault detection scheme further comprises: determining, based on the sampled phase voltages, if a fault is a phase-phase fault.

15. A computer-implemented method for detecting inter-circuit faults within a generator stator, the method comprising:
sampling phase voltages of the generator stator;
sampling phase currents of the generator stator;
enabling, based on the sampled phase voltages and phase currents, an inter-circuit fault detection scheme;
determining, in response to the enabling, a plurality of differences between the sampled RMS phase voltages; and
comparing, in response to the enabling, each of the differences of the sampled phase voltages and determining, based on the differences, an inter-circuit fault within at least one phase of the generator stator.

16. The computer-implemented method of claim 15, further comprising determining a negative sequence voltage, based on the sampled phase voltages, and determining if the negative sequence voltage is higher than a threshold.

17. The computer-implemented method of claim 15, further comprising comparing the sampled phase voltages, and determining if an unbalance between the sampled phase voltages is within a pre-defined limit.

18. The computer-implemented method of claim 15, wherein enabling the inter-circuit fault detection scheme further comprises: determining, based on the sampled phase voltages and current, if a fault is within the generator stator.

19. The computer-implemented method of claim 15, wherein enabling the inter-circuit fault detection scheme further comprises: determining, based on the sampled phase voltages, if a fault is a ground fault.

20. The computer-implemented method of claim 15, wherein enabling the inter-circuit fault detection scheme further comprises: determining, based on the sampled phase voltages, if a fault is a phase-phase fault.
